(19) United States
(12) Patent Application Publication
(10) Pub. No.: US 2019/0303866 A1
(43) Pub. Date: Oct. 3, 2019

(54) METHOD OF PROVIDING INFORMATION ABOUT LOGISTICS DELIVERY ROUTE BY USING FUTURE TRAFFIC INFORMATION AND SERVER FOR PERFORMING THE SAME

(71) Applicant: BLUESIGNAL CORPORATION, Daejeon (KR)

(72) Inventor: Sengtae BAIK, Daejeon (KR)

(21) Appl. No.: 16/147,666

(22) Filed: Sep. 29, 2018

(30) Foreign Application Priority Data
Mar. 29, 2018 (KR) 10-2018-0036331

(51) Int. Cl. G06Q 10/08; G01C 21/34; G08G 1/01; G06F 17/30; G06N 5/04

(52) U.S. Cl. CPC G06Q 10/08355; G01C 21/3492; G06N 5/046; G06F 17/30241; G08G 1/0129

(57) ABSTRACT

Disclosed herein is a method of providing information about a logistics delivery route by using future traffic information. The method includes: generating future traffic information by reference to a database in which region-based real-time traffic information during a period from a current time to a specific time has been stored; calculating travel times for a plurality of delivery sections based on the location of a logistics delivery person by using the future traffic information; generating a delivery route by using the travel times for the plurality of delivery sections, and providing information about the delivery route; and recalculating travel times for the remaining delivery sections based on the location of the logistics delivery person, updating the delivery route for the logistics delivery person, and providing information about the updated delivery route.

### CROSS-REFERENCE TO RELATED APPLICATION

This application claims under 35 U.S.C. § 119(a) the benefit of Korean Patent Application No. 10-2018-0036331 filed on Mar. 29, 2018, which is incorporated herein by reference in its entirety.

### BACKGROUND

### 1. Technical Field

The present invention relates to a method of providing information about a logistics delivery route by using future traffic information and a server for performing the method.

### 2. Description of the Related Art

With the recent rapid development of information and communication technology and the proliferation of Internet users, the electronic commerce (e-commerce) market has grown rapidly and global sourcing has expanded. In particular, the e-commerce market is a sector that is growing dramatically. The e-commerce market is a new type of distribution business that has great growth potential and grows steadily.

As the e-commerce market is performed by phone or online, courier service is mainly used for the transportation of purchased goods.

The history of courier service started from June of 1992. Courier service is designed to deliver goods or products, packaged by persons or companies, directly to required places. Although it is generally limited to one country, international logistics companies handle international courier services.

A courier system is a delivery system for delivering goods and documents that has emerged in accordance with the needs of users, and refers to a delivery system that visits senders, receives goods or documents to be delivered, and then visits recipients' premises and delivers the goods or documents to the recipients.

Examples of such a courier system include air courier services between countries or metropolitan cities, such as DHL, and domestic courier services between local areas or metropolitan areas within a country. Domestic courier services between local areas use land transportation means, such as freight vehicles, in order to deliver freight.

### SUMMARY

An object of the present invention is to provide a method of providing information about a logistics delivery route by using future traffic information, which predicts a road traffic-based logistics industry and a future traffic situation and reflects situations before and after delivery in an overall process, thereby providing an efficient logistics delivery system in preparation for the future traffic situation, and a server for performing the method.

Another object of the present invention is to provide a method of providing information about a logistics delivery route by using future traffic information, which provides a delivery route while taking into account a real-time traffic condition in order to reduce delivery time under given limited resources, such as delivery personnel, means, logistics bases, etc., thereby contributing to an increase in the efficiency of logistics delivery navigation service, and a server for performing the method.

Another object of the present invention is to provide a method of providing information about a logistics delivery route by using future traffic information, which enables various types of route selection during travel and the avoidance of unusual traffic congestion during holidays, a national event, etc. based on traffic congestion prediction information, and allows logistics, distribution and insurance company vehicles sensitive to traffic congestion to avoid traffic congestion, thereby reducing operation costs, and a server for performing the method.

Still another object of the present invention is to provide a method of providing information about a logistics delivery route by using future traffic information, which can minimize logistics costs due to a reduction in time costs resulting from future traffic congestion based on navigation service achieved via a route determination method capable of increasing the reliability of predicted time by applying a real-time traffic big data-based deep learning technique at an initial route planning point, and a server for performing the method.

The objects and various advantages of the present invention will be apparent to those skilled in the art from preferred embodiments of the present invention.

According to an aspect of the present invention, there is provided a method of providing information about a logistics delivery route by using future traffic information, the method being performed by a logistics delivery route provision server, the method including: when receiving a route request message from a logistics delivery person terminal, generating future traffic information by reference to a database in which region-based real-time traffic information during a period from the current time to a specific time has been stored; calculating travel times for a plurality of delivery sections based on the location of a logistics delivery person by using the future traffic information; generating a delivery route for the logistics delivery person by using the travel times for the plurality of delivery sections, and providing information about the delivery route via a car navigation device installed in the vehicle of the logistics delivery person; and when the future traffic information is updated or the logistics delivery person reaches a delivery section, recalculating travel times for the remaining delivery sections based on the location of the logistics delivery person, updating the delivery route for the logistics delivery person, and providing information about the updated delivery route.

According to another aspect of the present invention, there is provided a logistics delivery route provision server using future traffic information, the serer including: a database configured to store region-based real-time traffic information during a period from the current time to a specific time; a database management unit configured to manage the data of the database; a future traffic information generation unit configured to generate future traffic information by using the data stored in the database; a travel time calculation unit configured to, when receiving a route request message from a logistics delivery person terminal, calculate travel times for a plurality of delivery sections based on a location of a logistics delivery person by using the future traffic information by reference to the database; and a delivery route provision unit configured to generate a delivery route for the logistics delivery person by using the travel times for the plurality of delivery sections and provide information about the delivery route via a car navigation device installed in the vehicle of the logistics delivery person, and to, when the future traffic information is updated or the logistics delivery person reaches a delivery section, recalculate travel times for the remaining delivery sections based on the location of the logistics delivery person, update the delivery route for the logistics delivery person, and provide information about the updated delivery route.

The above-described solutions to the problems do not list all the features of the present invention. Various means for solving the problems of the present invention will be apparently understood from the specific embodiments of the following detailed description.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a system for providing information about a logistics delivery route by using future traffic information according to an embodiment of the present invention;

FIG. 2 is a block diagram illustrating the internal structure of a logistics delivery route provision server using future traffic information according to an embodiment of the present invention; and

FIG. 3 is a flowchart illustrating a method of providing information about a logistics delivery route by using future traffic information according to an embodiment the present invention.

### DETAILED DESCRIPTION

Preferred embodiments of the present invention will be described below with reference to the accompanying drawings.

However, embodiments of the present invention may be modified into various different forms, and the scope of the present invention is not limited to the following embodiments. Furthermore, the embodiments of the present invention are provided to more fully describe the present invention to those having ordinary knowledge in the art to the present invention pertains.

The meanings of the terms that are described in the present invention should be understood as follows:

A singular expression should be understood to include a plural expression, unless clearly expressed otherwise in the context. The terms, such as “include,” “have,” and their derivatives, should be understood to each indicate the presence of one or more features, numbers, steps, operations, components, parts, or combinations thereof, but should not be understood to each exclude the presence or possible addition of one or more other features, numbers, steps, operations, components, parts, or combination thereof.

Unless otherwise defined, all the terms used herein have the same meanings as being understood by those having ordinary knowledge in the technical field to which the present invention pertains. The terms commonly used and defined in dictionaries should be interpreted as having meanings identical to those specified in the context of related technology. Unless definitely defined therein, the terms should not be interpreted as having excessively ideal or formative meanings.

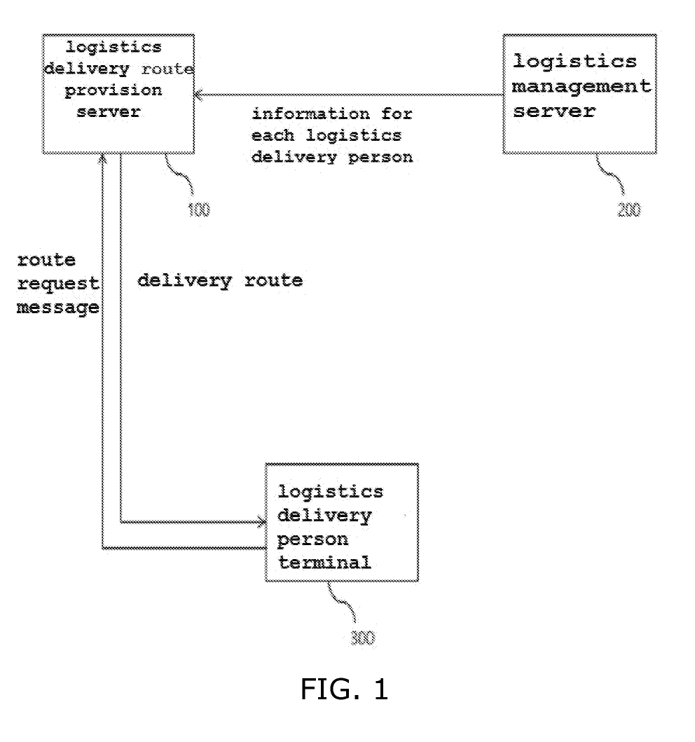

FIG. 1 is a view illustrating a system for providing information about a logistics delivery route by using future traffic information according to an embodiment of the present invention.

Referring to FIG. 1, the system for providing information about a logistics delivery route by using future traffic information includes a logistics delivery route provision server 100, a logistics management server 200, and a logistics delivery person terminal 300.

The logistics delivery route provision server 100 is a server that generates future traffic information based on a real-time traffic condition, generates a delivery route for a logistics delivery person by using the future traffic information, and provides information about the delivery route via a car navigation device installed in the vehicle of the logistics delivery person.

First, when the logistics delivery route provision server 100 receives a route request message from the logistics delivery person terminal 300, it generates future traffic information by reference to a database in which region-based real-time traffic information during a period from the current time to a specific time has been stored, and calculates travel times for a plurality of delivery sections based on the location of the logistics delivery person by using the future traffic information.

In the database, region-based real-time traffic information during a period from the current time to a specific time is stored. The real-time traffic information may be updated based on at least one of a road-based traffic accident history, real-time traffic information, real-time road link speed, real-time traffic accident information, traffic accident handling time predicted based on the real-time traffic accident information, whether the current date is a holiday, whether the current date is the day before a holiday, whether the current date is the day after a holiday, and a current region-based weather condition.

Accordingly, the logistics delivery route provision server 100 may generate future traffic information by using region-based real-time traffic information. In this case, the future traffic information may include future point-of-time and road-based status information (for example, smooth, slow, or congested). When the road-based status information relates to “smooth,” it may include the estimated time for being smooth and a reason for being smooth. When the road-based status information relates to “slow,” it may include the estimated time for being slow and a reason for being slow. In contrast, when the road-based status information relates to “congested,” the may include the estimated time for being congested and a reason for being congested.

In an embodiment, the logistics delivery route provision server 100 may calculate congestion time under the status of a corresponding road by using real-time traffic accident information and traffic accident handling time predicted based on the real-time traffic accident information, and may generate future traffic information indicating that another road connected to the corresponding road may be congested.

Thereafter, the logistics delivery route provision server 100 generates a delivery route for the logistics delivery person based on the location of the delivery person by using the travel times for the plurality of delivery sections, and provides information about the delivery route via a car navigation device installed in the vehicle of the logistics delivery person.

In an embodiment, the logistics delivery route provision server 100 may display and provide an accident risk level in real time when it is determined based on the road-based traffic accident history that a road corresponding to the delivery route for the logistics delivery person is an area where a traffic accident occurs frequently.

In another embodiment, the logistics delivery route provision server 100 provides notification of various future traffic situations related to traffic situations (a traffic congestion and an accident risk), which will occur during travel before a destination, in advance.

In still another embodiment, the logistics delivery route provision server 100 may select a low-risk route based on not only the risk of a current traveling state but also an overall accident risk level before a destination to thus enable the logistics delivery person to travel along the route.

In still another embodiment, the logistics delivery route provision server 100 may calculate a risk level based on information, such as the driving pattern of a logistics delivery person, real-time traffic information, past information about a selected route, real-time acceleration, a deceleration situation, the distance between vehicles, etc., via artificial intelligence-type algorithm, and may provide information about the risk level.

In still another embodiment, the logistics delivery route provision server 100 may notify a user of optimum departure time and estimated arrival time for a designated starting point and a designated destination.

The process in which the logistics delivery route provision server 100 generates a delivery route for a logistics delivery person will be described below.

The logistics delivery route provision server 100 selects a delivery section having the shortest travel time from among a plurality of delivery sections as a first delivery section.

Thereafter, the logistics delivery route provision server 100 calculates travel times for the remaining delivery sections based on the time required for delivery for the corresponding delivery section and the location of the corresponding delivery section by using the times required for delivery for the plurality of delivery sections, and selects a delivery section having the shortest travel time as a second delivery section.

The logistics delivery route provision server 100 generates a delivery route for the logistics delivery person by using the first delivery section and the second delivery section.

In other words, the logistics delivery route provision server 100 prompts the logistics delivery person to visit the delivery section having the shortest travel time selected from among the plurality of delivery section first, and recalculates travel times for the remaining delivery sections based on the time at which the corresponding time has elapsed and the location of the corresponding delivery section by taking into account the time for which the logistics delivery person stays in the corresponding delivery section.

For this purpose, the logistics delivery route provision server 100 receives delivery information for each logistics delivery person from the logistics management server 200, and calculates the times required for delivery for a plurality of delivery sections.

First, the logistics delivery route provision server 100 receives information about a plurality of delivery sections for each logistics delivery person, the number of articles for each delivery section to be delivered over the plurality of delivery sections, the number of articles to be delivered for the same recipient and the same sub-delivery section among the articles for each delivery section, and average delivery time based on the number of articles for each delivery section from the logistics management server 200.

Thereafter, the logistics delivery route provision server 100 calculates the times required for delivery for the plurality of delivery sections based on the number of articles to be delivered for the same recipient and the same sub-delivery section among the articles for each delivery section and the average delivery time based on the number of articles for each delivery section.

As described above, the reason why the logistics delivery route provision server 100 calculates the times required for delivery for the plurality of delivery sections is to prepare for a case where the travel time from a first delivery section to a second delivery section may vary depending on the time for which the logistics delivery person stays in the first delivery section when selecting the shortest delivery section from among the plurality of delivery sections as the first delivery section and then selecting one of the remaining delivery sections as the second delivery section based on the first delivery section in the process of generating a delivery route.

Accordingly, the logistics delivery route provision server 100 may receive delivery information for each logistics delivery person from the logistics management server 200, may calculate the times required for delivery for a plurality of delivery sections, and may generate a delivery route for the logistics delivery person based on the times required for delivery for delivery sections and the future traffic information.

As described above, the present invention predicts a road traffic-based logistics industry and a future traffic situation and reflects situations before and after delivery in an overall process, thereby providing an efficient logistics delivery system in preparation for the future traffic situation, and a server for performing the method.

The logistics management server 200 provides delivery information for each logistics delivery person to the logistics delivery route provision server 100. In this case, the delivery information for each logistics delivery person includes information about a plurality of delivery sections for each logistics delivery person, the number of articles for each delivery section to be delivered over the plurality of delivery sections, the number of articles to be delivered for the same recipient and the same sub-delivery section among the articles for each delivery section, and average delivery time based on the number of articles for each delivery section. Accordingly, the logistics delivery route provision server 100 may calculate the times required for delivery for the plurality of delivery sections by using the delivery information for each logistics delivery person received from the logistics management server 200, and may generate a delivery route for the logistics delivery person based on the times required for delivery for the plurality of delivery sections and the future traffic information.

The logistics delivery person terminal 300 is a terminal that receives guidance on a delivery route from the logistics delivery route provision server 100 via a car navigation device installed in a vehicle and that is carried by a delivery person. The logistics delivery person terminal 300 may be implemented as a smartphone, a tablet PC, or the like.

The logistics delivery person terminal 300 may provide a route request message to the logistics delivery route provision server 100, and may receive information about a delivery route via a car navigation device installed in a vehicle.

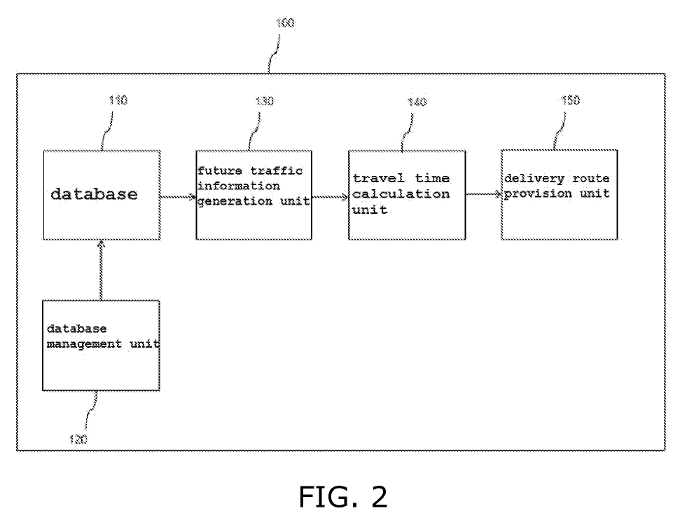

FIG. 2 is a block diagram illustrating the internal structure of a logistics delivery route provision server 100 using future traffic information according to an embodiment of the present invention.

Referring to FIG. 2, the logistics delivery route provision server 100 using future traffic information includes a database 110, a database management unit 120, a future traffic information generation unit 130, a travel time calculation unit 140, and a delivery route provision unit 150.

In the database 110, region-based real-time traffic information during a period from the current time to a specific time is stored. The information stored in the database 110 may be managed by the database management unit 120. Accordingly, the time traffic information stored in the database 110 may be updated by the database management unit 120.

The real-time traffic information stored in the database 110 may be used to calculate travel times for a plurality of delivery sections based on the location of a logistics delivery person.

The database management unit 120 manages the data of the database 110, generates region-based real-time traffic information during a period from the current time to a specific time based on information received from the outside, and updates the information stored in the database 110.

In an embodiment, the database management unit 120 generates the region-based real-time traffic information during a period from the current time to a specific time based on at least one of a road-based traffic accident history, real-time traffic information, real-time road link speed, real-time traffic accident information, traffic accident handling time predicted based on the real-time traffic accident information, whether the current date is a holiday, whether the current date is the day before a holiday, whether the current date is the day after a holiday, and a current region-based weather condition, and updates the information stored in the database 110.

The future traffic information generation unit 130 generates future traffic information by reference to the database 110. In this case, the future traffic information includes future point of time and road-based status information (for example, smooth, slow, and congested). When the road-based status information relates to “smooth,” it may include the estimated time for being smooth and a reason for being smooth. When the road-based status information relates to “slow,” it may include the estimated time for being slow and a reason for being slow. In contrast, when the road-based status information relates to “congested,” it may include the estimated time for being congested and a reason for being congested. Thereafter, the travel time calculation unit 140 calculates travel times for the plurality of delivery sections based on the location of the logistics delivery person by using the future traffic information generated by the future traffic information generation unit 130.

In this case, the real-time traffic information may be smooth, slow, or congested. When the real-time traffic information relates to “smooth,” it may include the estimated time for being smooth. When the real-time traffic information relates to “slow,” it may include the estimated time for being slow. In contrast, when the real-time traffic information relates to “congested,” it may include the estimated time for being congested and a reason for being congested.

The reason why the travel time calculation unit 140 calculates travel times for the plurality of delivery sections based on the location of the logistics delivery person by using the future traffic information generated by the future traffic information generation unit 130 is to prompt the logistics delivery person to visit a delivery section having the shortest travel time selected from among the plurality of delivery sections. However, the time for which the logistics delivery person stays in each delivery section may vary. After the corresponding time has elapsed, travel times for the remaining delivery sections may vary.

Accordingly, the present invention may calculate travel times for the remaining delivery sections at the time when the logistics delivery person departs based on a corresponding delivery destination by taking into account the time for which the logistics delivery person stays in each delivery section.

For this purpose, the travel time calculation unit 140 receives information about a plurality of delivery sections for each logistics delivery person, the number of articles for each delivery section to be delivered over the plurality of delivery sections, the number of articles to be delivered for the same recipient and the same sub-delivery section among the articles for each delivery section, and average delivery time based on the number of articles for each delivery section from the logistics management server 200.

Thereafter, the travel time calculation unit 140 calculates the times required for delivery for the plurality of delivery sections of the logistics delivery person based on the number of articles to be delivered for the same recipient and the same sub-delivery section among the articles for each delivery section and the average delivery time based on the number of articles for each delivery section.

Accordingly, the travel time calculation unit 140 may calculate travel times for the remaining delivery sections based on the time at which the time required for delivery for a corresponding delivery section has elapsed and the location of the corresponding delivery section by using the calculated times required for delivery for the plurality of delivery sections.

Accordingly, the delivery route provision unit 150 may generate a delivery route for the logistics delivery person based on the times required for delivery for the plurality of delivery sections and the future traffic information.

The delivery route provision unit 150 generates a delivery route for the logistics delivery person based on the location of the delivery person calculated by the travel time calculation unit 140 by using the travel times for the plurality of delivery sections, and provides information about the delivery route via a car navigation device installed in the vehicle of the logistics delivery person.

More specifically, the delivery route provision unit 150 selects a delivery section, having a travel time that is the shortest of all the travel times for the plurality of delivery sections calculated by the travel time calculation unit 140, as a first delivery section, and selects a delivery section, having a travel time that is the shortest of all the travel times for the remaining delivery sections calculated by the travel time calculation unit 140, as a second delivery section. Thereafter, the delivery route provision unit 150 generates a delivery route for the logistics delivery person by using the first delivery section and the second delivery section.

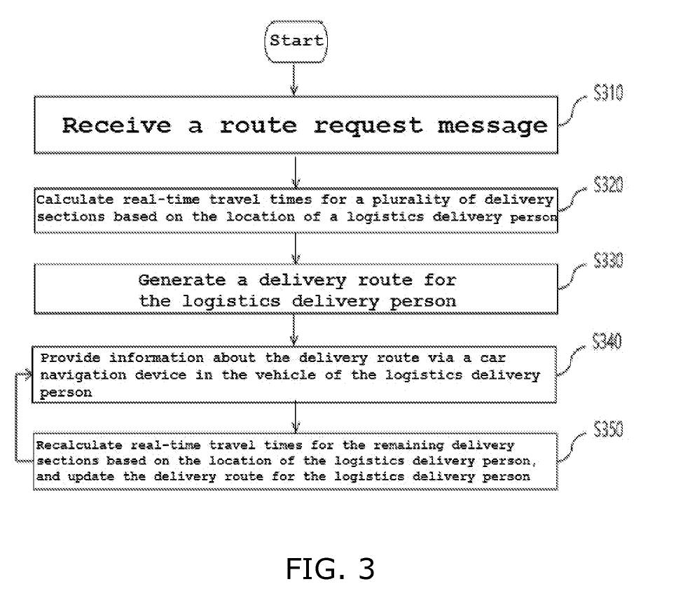

FIG. 3 is a flowchart illustrating a method of providing information about a logistics delivery route by using future traffic information according to an embodiment the present invention.

Referring to FIG. 3, when the logistics delivery route provision server 100 receives a route request message from the logistics delivery person terminal at step S310, it generates future traffic information by reference to the database in which region-based real-time traffic information during a period from the current time to a specific time has been stored, and calculates travel times for a plurality of delivery sections based on the location of a logistics delivery person by using the future traffic information at step S320.

In the database, region-based real-time traffic information during a period from the current time to a specific time is stored. The real-time traffic information may be updated based on at least one of a road-based traffic accident history, real-time traffic information, real-time road link speed, real-time traffic accident information, traffic accident handling time predicted based on the real-time traffic accident information, whether the current date is a holiday, whether the current date is the day before a holiday, whether the current date is the day after a holiday, and a current region-based weather condition.

The logistics delivery route provision server 100 generates a delivery route for the logistics delivery person by using the travel times for the plurality of delivery sections at step S330, and provides information about the delivery route via a car navigation device installed in the vehicle of the logistics delivery person at step S340.

The logistics delivery route provision server 100 recalculates travel times for the remaining delivery sections based on the location of the logistics delivery person when the future traffic information is changed or the logistics delivery person reaches the delivery section at step S350, and update and provides the delivery route for the logistics delivery person at step S340.

According to an embodiment of the present invention, an advantage is achieved in that a road traffic-based logistics industry and a future traffic situation are predicted and situations before and after delivery are reflected in an overall process, thereby providing an efficient logistics delivery system in preparation for the future traffic situation.

Furthermore, according to an embodiment of the present invention, an advantage is achieved in that a delivery route is provided while taking into account a real-time traffic condition in order to reduce delivery time under given limited resources, such as delivery personnel, means, logistics bases, etc., thereby contributing to an increase in the efficiency of logistics delivery navigation service.

Furthermore, according to an embodiment of the present invention, an advantage is achieved in that various types of route selection during travel and the avoidance of unusual traffic congestion during holidays, a national event, etc. are enabled based on traffic congestion prediction information and logistics, distribution, and insurance company vehicles sensitive to traffic congestion are allowed to avoid traffic congestion, thereby reducing operation costs.

Moreover, according to an embodiment of the present invention, an advantage is achieved in that logistics costs can be minimized due to a reduction in time costs resulting from future traffic congestion based on navigation service obtained via a route determination method capable of increasing the reliability of predicted time by applying a real-time traffic big data-based deep learning technique at an initial route planning point.

Since the foregoing description of the present invention is intended to illustrate embodiments for the purpose of providing structural and functional descriptions, the scope of the present invention should not be construed as being limited by the embodiments described above. In other words, the present invention is not limited by the above-described embodiments and the accompanying drawings, but is defined by the attached claims. The configuration of the present invention may be modified and altered in various manners without departing from the technical spirit of the present invention. Accordingly, embodiments of the present invention may be modified in various forms, and may have various forms. Therefore, the scope of the present invention encompasses equivalents that can implement the technical spirit of the present invention.

What is claimed is:

1. A method of providing information about a logistics delivery route by using future traffic information, the method being performed by a logistics delivery route provision server, the method comprising:
when receiving a route request message from a logistics delivery person terminal, generating future traffic information by reference to a database in which region-based real-time traffic information during a period from a current time to a specific time has been stored;
calculating travel times for a plurality of delivery sections based on a location of a logistics delivery person by using the future traffic information;
generating a delivery route for the logistics delivery person by using the travel times for the plurality of delivery sections, and providing information about the delivery route via a car navigation device installed in a vehicle of the logistics delivery person; and
when the future traffic information is updated or the logistics delivery person reaches a delivery section, recalculating travel times for the remaining delivery sections based on the location of the logistics delivery person, updating the delivery route for the logistics delivery person, and providing information about the updated delivery route.

2. The method of claim 1, further comprising generating the region-based real-time traffic information during a period from a current time to a specific time based on at least one of a road-based traffic accident history, real-time traffic information, real-time road link speed, real-time traffic accident information, traffic accident handling time predicted based on the real-time traffic accident information, whether a current date is a holiday, whether a current date is a day before a holiday, whether a current date is a day after a holiday, and a current region-based weather condition, and updating the database.

3. The method of claim 1, wherein:
generating future traffic information comprises generating future traffic information including future point of time and road-based status information by using the region-based real-time traffic information; and
when the status information relates to “smooth,” it includes an estimated time for being smooth and a reason for being smooth; when the status information relates to “slow,” it includes an estimated time for being slow and a reason for being slow; and, when the status information relates to “congested,” it includes an estimated time for being congested and a reason for being congested.

4. The method of claim 1, further comprising:
receiving the plurality of delivery sections for the logistics delivery person, a number of articles for each delivery section to be delivered over the plurality of delivery sections, a number of articles to be delivered for an identical recipient and an identical sub-delivery section among the articles for each delivery section, and an average delivery time based on the number of articles for each delivery section from a logistics management server; and
calculating times required for delivery for the plurality of delivery sections of the logistics delivery person based on the number of articles to be delivered for an identical recipient and an identical sub-delivery section among the articles for each delivery section, and the average delivery time based on the number of articles for each delivery section.

5. The method of claim 4, wherein calculating the travel times comprises:
selecting a delivery section having a shortest travel time from among the plurality of delivery sections as a first delivery section;
calculating future travel times for the remaining delivery sections based on a time at which the time required for delivery for the corresponding delivery section has elapsed and the location of the corresponding delivery section by using the times required for delivery for the plurality of delivery sections, and selecting a delivery section having a shortest travel time as a second delivery section; and
generating a delivery route for the logistics delivery person by using the first delivery section and the second delivery section.

6. A logistics delivery route provision server using future traffic information, the serer comprising:
a database configured to store region-based real-time traffic information during a period from a current time to a specific time;
a database management unit configured to manage data of the database;
a future traffic information generation unit configured to generate future traffic information by using the data stored in the database;
a travel time calculation unit configured to, when receiving a route request message from a logistics delivery person terminal, calculate travel times for a plurality of delivery sections based on a location of a logistics delivery person by using the future traffic information by reference to the database; and
a delivery route provision unit configured to generate a delivery route for the logistics delivery person by using the travel times for the plurality of delivery sections and provide information about the delivery route via a car navigation device installed in a vehicle of the logistics delivery person, and to, when the future traffic information is updated or the logistics delivery person reaches a delivery section, recalculate travel times for the remaining delivery sections based on the location of the logistics delivery person, update the delivery route for the logistics delivery person, and provide information about the updated delivery route.

7. The logistics delivery route provision server of claim 6, wherein the database management unit is further configured to generate the region-based real-time traffic information during a period from a current time to a specific time based on at least one of a road-based traffic accident history, real-time traffic information, real-time road link speed, real-time traffic accident information, traffic accident handling time predicted based on the real-time traffic accident information, whether a current date is a holiday, whether a current date is a day before a holiday, whether a current date is a day after a holiday, and a current region-based weather condition, and to update the database.

8. The logistics delivery route provision server of claim 6, wherein:
the future traffic information generation unit is further configured to generate future traffic information comprises generating future traffic information including future point of time and road-based status information by using the region-based real-time traffic information; and
when the status information relates to “smooth,” it includes an estimated time for being smooth and a reason for being smooth; when the status information relates to “slow,” it includes an estimated time for being slow and a reason for being slow; and, when the status information relates to “congested,” it includes an estimated time for being congested and a reason for being congested.

9. The logistics delivery route provision server of claim 6, wherein the travel time calculation unit is further configured to:
receive the plurality of delivery sections for the logistics delivery person, a number of articles for each delivery section to be delivered over the plurality of delivery sections, a number of articles to be delivered for an identical recipient and an identical sub-delivery section among the articles for each delivery section, and an average delivery time based on the number of articles for each delivery section from a logistics management server; and
calculate times required for delivery for the plurality of delivery sections of the logistics delivery person based on the number of articles to be delivered for an identical recipient and an identical sub-delivery section among the articles for each delivery section, and the average delivery time based on the number of articles for each delivery section.

10. The logistics delivery route provision server of claim 9, wherein:
the travel time calculation unit is further configured to calculate future travel times for the remaining delivery sections based on a time at which the time required for delivery for the corresponding delivery section has elapsed and the location of the corresponding delivery section by using the times required for delivery for the plurality of delivery sections; and
the delivery route provision unit is further configured to select a delivery section having a shortest travel time from among the a plurality of delivery sections as a first delivery section, to select a delivery section having a shortest travel time as a second delivery section, and to generate a delivery route for the logistics delivery person by using the first delivery section and the second delivery section.
